(19) United States
(12) Patent Application Publication
(10) Pub. No.: US 2015/0146107 A1
(43) Pub. Date: May 28, 2015

(54) Methods to Reduce Bit-Depth Required for Linearizing Data

(71) Applicant: Apple Inc., Cupertino, CA (US)

(72) Inventors: Ken Greenebaum, San Carlos, CA (US); Ian Hendry, San Jose, CA (US); David Hayward, Los Altos, CA (US)

(21) Appl. No.: 14/502,733

(22) Filed: Sep. 30, 2014

Related U.S. Application Data
(60) Provisional application No. 61/909,215, filed on Nov. 26, 2013.

(51) Int. Cl. H04N 9/64

(52) U.S. Cl. CPC H04N 9/646
USPC 348/674

(57) ABSTRACT

Media is usually encoded using a non-linear transfer function that approximates human perception to more efficiently allocate codes to areas of dynamic range where human observers are more easily able to perceive differences in signal strength. Many common media operations, e.g., scaling, rotating, and gamut converting, must be performed in a linear representation to be correct and artifact-free. The non-linear transfer functions used are often pure-power functions, such as “gamma” functions. To avoid banding after transformation, as many as 17 bits are needed in the linear-space with 8-bit input. Thus, methods, computer readable media, and systems for reducing the number of bits required in the linear domain are described herein that substitute a piecewise linear function (e.g., a line segment followed by an offset curve) for a pure-power gamma function, such that a slope limit is applied to constrain the number of (additional) linear bits required (over the input precision).

### BACKGROUND

This disclosure relates generally to the field of data processing and, more particularly, to various techniques to reduce the bit-depth required for satisfactory linearization of data, e.g., data that is to be displayed on a monitor or other type of display surface, saved to a file, printed, played as audio, further processed, transmitted, or analyzed, etc.

Gamma adjustment, or, as it is often simply referred to, “gamma,” is the name given to the nonlinear operation commonly used to encode linear luma values. Gamma, γ, may be defined by the following simple power-law expression: Lₒᵤₜ=Lᵢₙ^{γ}, where the input and output values, Lᵢₙ and Lₒᵤₜ, respectively, are non-negative real values, typically in a predetermined range, e.g., zero to one. In other embodiments, referred to herein as “extended range” embodiments, the values of Lᵢₙ and Lₒᵤₜ may include positive and negative real numbers in a range that is greater than zero to one, e.g., −0.75, −1.25, etc. In the case of extended range embodiments, the power-law expression may be modified as follows: Lₒᵤₜ=(Lᵢₙ/|Lᵢₙ|)|Lᵢₙ|^{γ}. A gamma value greater than one is sometimes called an encoding gamma, and the process of encoding with this compressive power-law nonlinearity is called gamma compression; conversely, a gamma value less than one is sometimes called a decoding gamma, and the application of the expansive power-law nonlinearity is called gamma expansion. Gamma encoding maps linear data into a more perceptually uniform domain.

Another way to think about the gamma characteristic of a system is as a power-law relationship that approximates the relationship between the encoded luma in the system and the actual desired image luminance on whatever the eventual user display device is. Other uses of gamma may include: encoding between the physical world and media; decoding media data to linear space; and converting display linear data to the display's response space. In existing systems, a computer processor or other suitable programmable control device may perform gamut adjustment computations for a particular display device it is in communication with based on the native luminance response (often called the “EOTF,” or electrical optical transfer function) of the display device, the color gamut of the device, and the device's white point (which information may be stored in an ICC profile), as well as the ICC color profile the source content's author attached to the content to specify the content's “rendering intent.” The ICC profile is a set of data that characterizes a color input or output device, or a medium, according to standards promulgated by the International Color Consortium (ICC). ICC profiles may describe the color attributes of a particular device or viewing requirement by defining a mapping between the device source or target color space and a profile connection space (PCS), usually the CIE XYZ color space.

In some embodiments, image values, e.g., red, green, and blue pixel values or luma values, enter a “framebuffer” having come from an application or applications that have already processed the image values to be encoded with a specific implicit gamma. A framebuffer may be defined as a video output device that drives a video display from a memory buffer containing a complete frame of, in this case, image data. The implicit gamma of the values entering the framebuffer can be visualized by looking at the “Framebuffer Gamma Function,” as will be explained further below. Ideally, this Framebuffer Gamma Function is the exact inverse of the display device's “Native Display Response” function, which characterizes the luminance response of the display to input, to yield unity system response. However, because the inverse of the Native Display Response isn't always exactly the inverse of the framebuffer, a “Look Up Table” (LUT), sometimes stored and implemented on a video card, may be used to accommodate for the imperfections in the relationship between the encoding gamma and decoding gamma values, as well as the display's particular luminance response characteristics.

As mentioned above, media is usually encoded by a non-linear transfer function that approximates human perception, and is then quantized in the gamma corrected space to efficiently allocate codes (a linear representation may dramatically over allocate codes to areas near white that human observers may see as mainly the same, and provide too few in areas near black that are more easily observed as being different). This is true for most any perceptual system including, but not limited to: vision, hearing, sense of touch, smell, taste, etc.

Many common operations on media must be performed in a linear representation to be correct and artifact-free. These include, but are not limited to: scaling, rotating, compositing, and gamut converting. The transfer functions, as defined by human perception, and as commonly used by content providers in practice, are often pure-power functions (as described above), referred to herein as “gamma” functions.

These pure-power gamma functions asymptotically reach a slope of zero near an input value of zero (i.e., pure black for image data). Consequently, for a given quantized precision input (usually described in terms of bit-depth), dramatically more bits are required for the linear output space to meet the requirement that every unique input value produce a unique output value, such that the original signal may be reproduced by applying the inverse gamma function. Banding artifacts are produced if these criteria are not met. For a common image case, input data may be 8-bit quantized with 2.2 gamma. To avoid banding, as many as 17 bits are needed in the linear-space (this number may be verified empirically).

The inventors have realized new and non-obvious ways to reduce the bit-depth required to linearize data for the performance of image processing operations without the introduction of banding artifacts—or with significantly reduced banding artifacts. The inventors have also realized new and non-obvious ways to further reduce the bit depth needed before processing, e.g., via the use of stochastic dithering.

### SUMMARY

Methods, computer readable media, and systems of reducing the number of bits required in the linear domain are described herein. In some embodiments, a piecewise linear function (e.g., a linear segment followed by an offset curve) is substituted for the pure-power function, such that a slope limit of the linear segment is applied to constrain the number of (additional) linear bits required (over the input precision) to a desired number. In some embodiments, the offset curve following the linear segment may be modeled using a pure-power curve. In still other embodiments, the offset curve may be modeled as a second-order, third-order (or other-order) polynomial function that is solved for using numerical methods and one or more predetermined constraints.

Exemplary constraints that may be applied to the process of modeling the piecewise linear transfer function include: 1) the offset curve intersects the point (1,1) (assuming input and output values are scaled to the range 0.1); 2) the slope of the linear segment may be limited based on the number of additional bits, i.e., the number of bits needed beyond the input precision/quantization, that the implementation is willing to use in linear space; 3) the linear segment and offset curve are continuous with one another at the input value where they intersect; 4) the slopes of the linear segment and offset curve are continuous with one another at the input value where they intersect; 5) the area under the piecewise linear transfer function curve is the same as what the area under the ideal “pure power” curve would be; and 6) the mean square error (or other quality metric, e.g., a perceptual quality metric) is minimized between the piecewise linear transfer function curve and the ideal “pure power” curve.

Applying these techniques, the additional number of bits required in the linear space may be reduced from nine to four or fewer—depending on the acceptable level of difference between the curves (differences between the modeled piecewise linear functions and the pure-power curve will appear as subtle tone shifts at reasonable levels of bit conservation).

To further reduce bit requirements for linear-space computations (such as scaling), a stochastic dither may be applied preceding a quantization. For instance, with 8-bit, 2.2 gamma input data linearized using the aforementioned piecewise linear function techniques, only 12 bits may be required in linear space (to avoid banding artifacts), versus the 17 bits that would be required if a pure power transfer function were used. If stochastic noise is also added (e.g., centered at the quantization's least significant bit), the signal may further be quantized to, e.g., 10 bits for further linear-space computation without creating objectionable artifacts. Since scalars and other linear-space computations are expensive, any bit reductions save greatly in terms of transistors, space, power, and computational expense.

Thus, in one embodiment disclosed herein, a non-transitory program storage device, readable by a programmable control device, may comprise instructions stored thereon to cause the programmable control device to: receive non-linear encoded input data, wherein the received non-linear encoded input data has a first quantized bit-depth; determine a first transfer function; and transform the received non-linear encoded input data into linear output data having a second quantized bit-depth according to the first transfer function, wherein the first transfer function comprises a piecewise linear function, the piecewise linear function defined by a first linear segment followed, after a first input value, by an offset curve, wherein the first linear segment is continuous with the offset curve at the first input value, and wherein the slopes of the first linear segment and the offset curve at the first input value are the same.

In still other embodiments, the techniques described herein may be implemented in apparatuses and/or systems, such as electronic devices having memory and programmable control devices.

### BRIEF DESCRIPTION OF THE DRAWINGS

FIG. 1 illustrates a system for performing gamma adjustment utilizing a look up table, in accordance with the prior art.

FIG. 2 illustrates a Framebuffer Gamma Function and an exemplary Native Display Response, in accordance with the prior art.

FIG. 3 illustrates a graph representative of a LUT transformation and a Resultant Gamma Function, in accordance with the prior art.

FIG. 4 illustrates a graph of a plurality of gamma functions with increasing gamma values.

FIG. 5 illustrates a graph of an exemplary piecewise linear transfer function, in accordance with one embodiment.

FIG. 6 illustrates the process of linear transformation and inverse linear transformation in block diagram form.

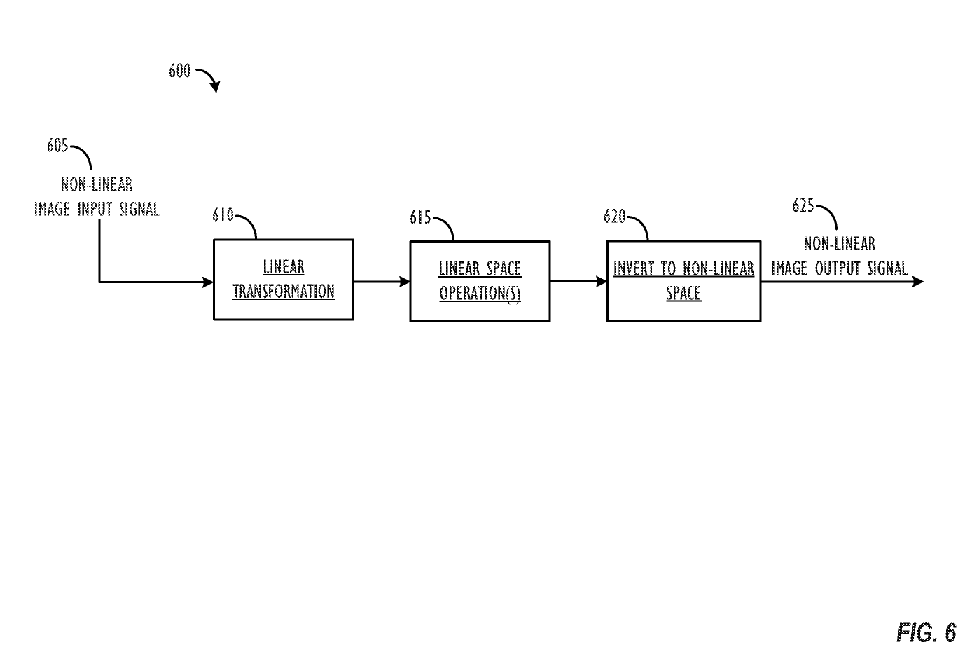

FIG. 7 illustrates a process of reducing the bit-depth required for linearizing data in flowchart form, and in accordance with one embodiment.

FIG. 8 illustrates a system for performing graphical operations in linear space, in accordance with one embodiment.

FIG. 9 illustrates a simplified functional block diagram of an illustrative electronic device, according to one embodiment

### DETAILED DESCRIPTION

This disclosure pertains to systems, methods, and computer readable media for reducing the number of bits required in the linear domain for performing operations on encoded input data without producing noticeable artifacts. The techniques disclosed herein are applicable to any number of electronic devices, such as: digital cameras, digital video cameras, mobile phones, personal data assistants (PDAs), portable music players, monitors, televisions, and, of course, desktop, laptop, and tablet computer displays.

In the following description, for purposes of explanation, numerous specific details are set forth in order to provide a thorough understanding of the inventive concept. As part of this description, some of this disclosure's drawings represent structures and devices in block diagram form in order to avoid obscuring the invention. In the interest of clarity, not all features of an actual implementation are described in this specification. Moreover, the language used in this disclosure has been principally selected for readability and instructional purposes, and may not have been selected to delineate or circumscribe the inventive subject matter, resort to the claims being necessary to determine such inventive subject matter. Reference in this disclosure to “one embodiment” or to “an embodiment” means that a particular feature, structure, or characteristic described in connection with the embodiment is included in at least one implementation of the invention, and multiple references to “one embodiment” or “an embodiment” should not be understood as necessarily all referring to the same embodiment.

It will be appreciated that, in the development of any actual implementation (as in any development project), numerous decisions must be made to achieve the developers' specific goals (e.g., compliance with system- and business-related constraints), and that these goals may vary from one implementation to another. It will also be appreciated that such development efforts might be complex and time-consuming, but would nevertheless be a routine undertaking for those of ordinary skill in the design of an implementation of image processing systems having the benefit of this disclosure.

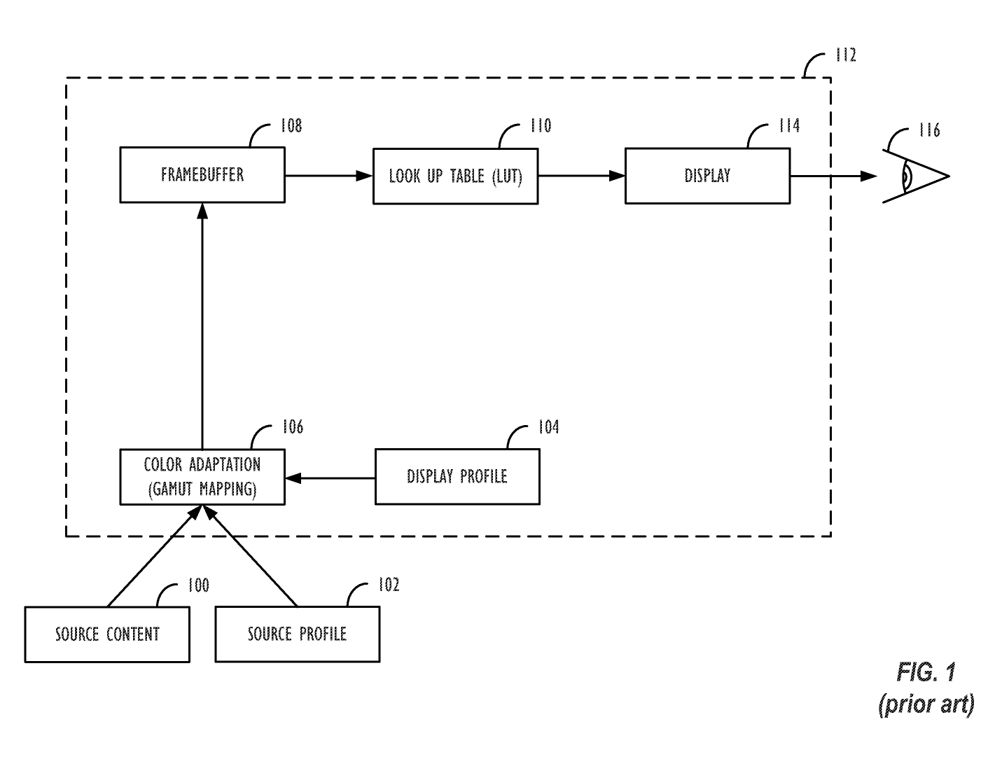

Referring now to FIG. 1, a system 112 for performing gamma adjustment utilizing a Look Up Table (LUT) 110 is shown. Element 100 represents the source content, created by, e.g., a source content author, that viewer 116 wishes to view. Source content 100 may comprise an image, video, graphic, text, or other displayable content type. Element 102 represents the source profile, that is, information describing the color profile and display characteristics of the device on which source content 100 was authored by the source content author. Source profile 102 may comprise, e.g., an ICC profile of the author's device or color space, or other related information.

Information relating to the source content 100 and source profile 102 may be sent to viewer 116's device containing the system 112 for performing gamma adjustment utilizing a LUT 110. Viewer 116's device may comprise, for example, a mobile phone, PDA, portable music player, monitor, television, or a laptop, desktop, or tablet computer. Upon receiving the source content 100 and source profile 102, system 112 may perform a color adaptation process 106 on the received data, e.g., utilizing the COLORSYNC® framework. (COLORSYNC® is a registered trademark of Apple Inc.) COLORSYNC® provides several different methods of doing gamut mapping, i.e., color matching across various color spaces. For instance, perceptual matching tries to preserve as closely as possible the relative relationships between colors, even if all the colors must be systematically distorted in order to get them to display on the destination device.

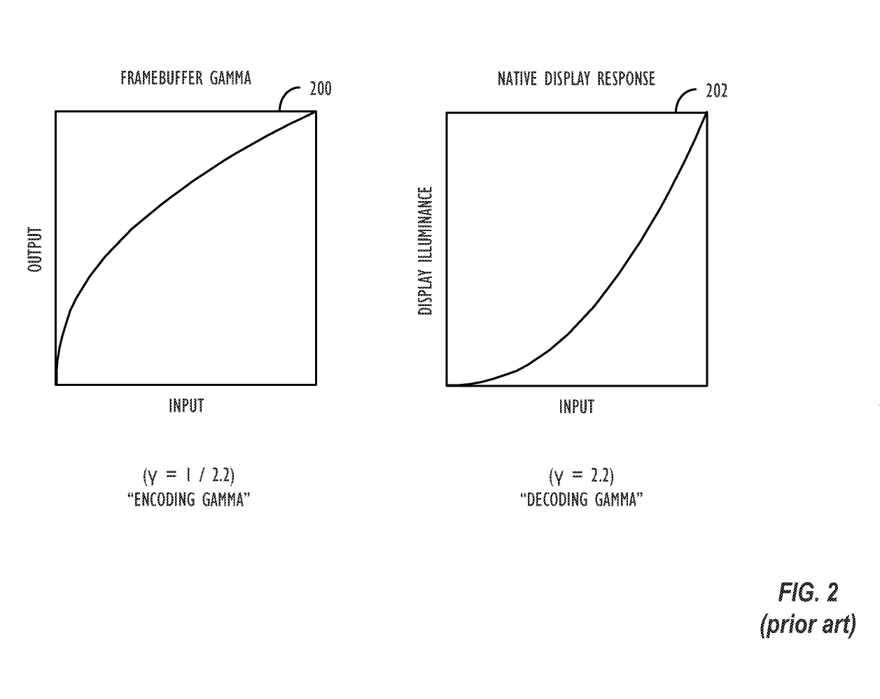

Once the color profiles of the source and destination have been appropriately adapted, image values may enter the framebuffer 108. In some embodiments, the image values entering framebuffer 108 will already have been processed and have a specific implicit gamma, i.e., the Framebuffer Gamma function, as will be described later in relation to FIG. 2. In some embodiments, the image values may need to be converted into linear space so that additional operations may be performed on the data before the data is inverted back to non-linear space for display. In other embodiments, the image values may undergo linear space scaling, color space conversion, and/or compositing before entering framebuffer 108. In still other embodiments, some operations may also be performed on the image values after exiting the framebuffer 108. For example, a color space conversion may be done to convert the image values from a canonical framebuffer color space to a specific color space of the display, e.g., a “panel fit” scale. Various novel and non-obvious techniques to reduce the number of bits needed during this conversion to linear space are further described in this disclosure.

System 112 may then utilize a LUT 110 to perform a so-called “gamma adjustment process.” LUT 110 may comprise a two-column table of positive, real values spanning a particular range, e.g., from zero to one. The first column values may correspond to an input image value, whereas the second column value in the corresponding row of the LUT 110 may correspond to an output image value that the input image value will be “transformed” into before being ultimately being displayed on display 114. LUT 110 may be used to account for the imperfections in the display 114's luminance response curve, also known as a transfer function, or “EOTF.” In other embodiments, a LUT may have separate channels for each primary color in a color space, e.g., a LUT may have Red, Green, and Blue channels in the sRGB color space.

As mentioned above, in some embodiments, the goal of this gamma adjustment system 112 is to have an overall 1.0 gamma boost applied to the content that is being displayed on the display device 114. An overall 1.0 gamma boost corresponds to a linear relationship between the input encoded luma values and the output luminance on the display device 114. Ideally, an overall 1.0 gamma boost will correspond to the source author's intended look of the displayed content.

Referring now to FIG. 2, a Framebuffer Gamma Function 200 and an exemplary Native Display Response 202 is shown. The x-axis of Framebuffer Gamma Function 200 represents input image values spanning a particular range, e.g., from zero to one. The y-axis of Framebuffer Gamma Function 200 represents output image values spanning a particular range, e.g., from zero to one. As mentioned above, in some embodiments, image values may enter the framebuffer 108 already having been processed and have a specific implicit gamma. As shown in graph 200 in FIG. 2, the encoding gamma is roughly 1/2.2, or 0.45. That is, the line in graph 200 roughly looks like the function, L_{OUT}=L_{IN}^{0.45}. Gamma values around 1/2.2, or 0.45, are typically used as encoding gammas because the native display response of many display devices have a gamma of roughly 2.2, that is, the inverse of an encoding gamma of 1/2.2.

The x-axis of Native Display Response Function 202 represents input image values spanning a particular range, e.g., from zero to one. The y-axis of Native Display Response Function 202 represents output image values spanning a particular range, e.g., from zero to one. In theory, systems in which the decoding gamma is the inverse of the encoding gamma should produce the desired overall 1.0 gamma boost. However, this system does not take into account the effect on the viewer due to ambient light in the environment around the display device. Thus, the desired overall 1.0 gamma boost may only be achieved in certain ambient lighting environment conditions.

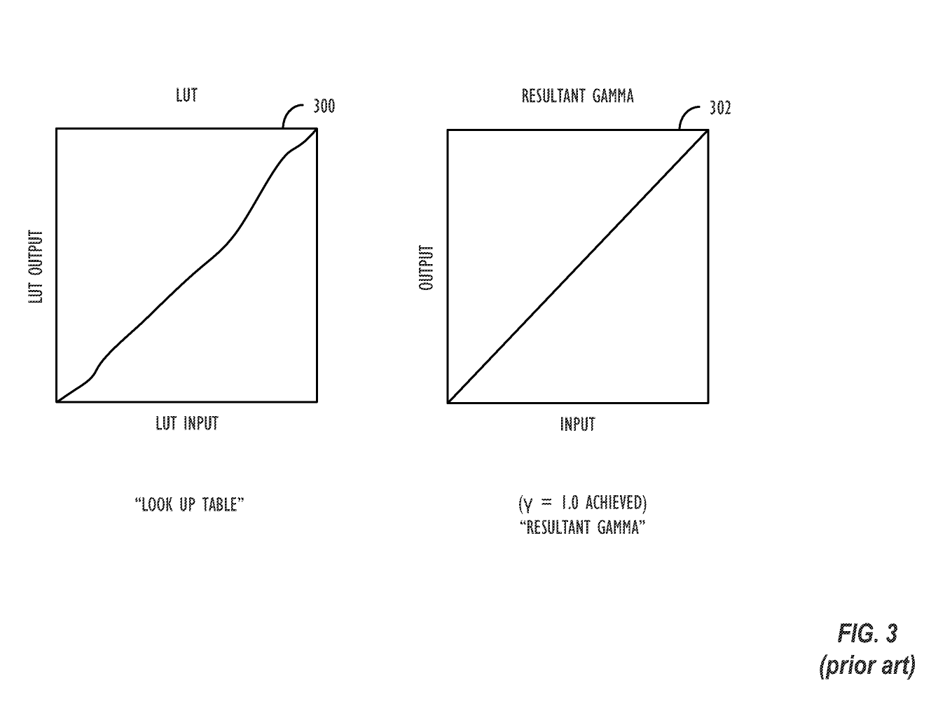

Referring now to FIG. 3, a graph representative of a LUT transformation 300 and a Resultant Gamma Function 302 are shown. The graphs in FIG. 3 show how, in an ideal system, a LUT may be utilized to account for the imperfections in the relationship between the encoding gamma and decoding gamma values, as well as the display's particular luminance response characteristics at different input levels. The x-axis of LUT graph 300 represents input image values spanning a particular range, e.g., from zero to one. The y-axis of LUT graph 300 represents output image values spanning a particular range, e.g., from zero to one. Resultant Gamma Function 302 reflects a desired overall 1.0 gamma boost resulting from the gamma adjustment provided by the LUT. The x-axis of Resultant Gamma Function 302 represents input image values as authored by the source content author spanning a particular range, e.g., from zero to one. The y-axis of Resultant Gamma Function 302 represents output image values displayed on the resultant display spanning a particular range, e.g., from zero to one. The slope of 1.0 reflected in the line in graph 302 indicates that luminance levels intended by the source content author will be reproduced at corresponding luminance levels on the ultimate display device.

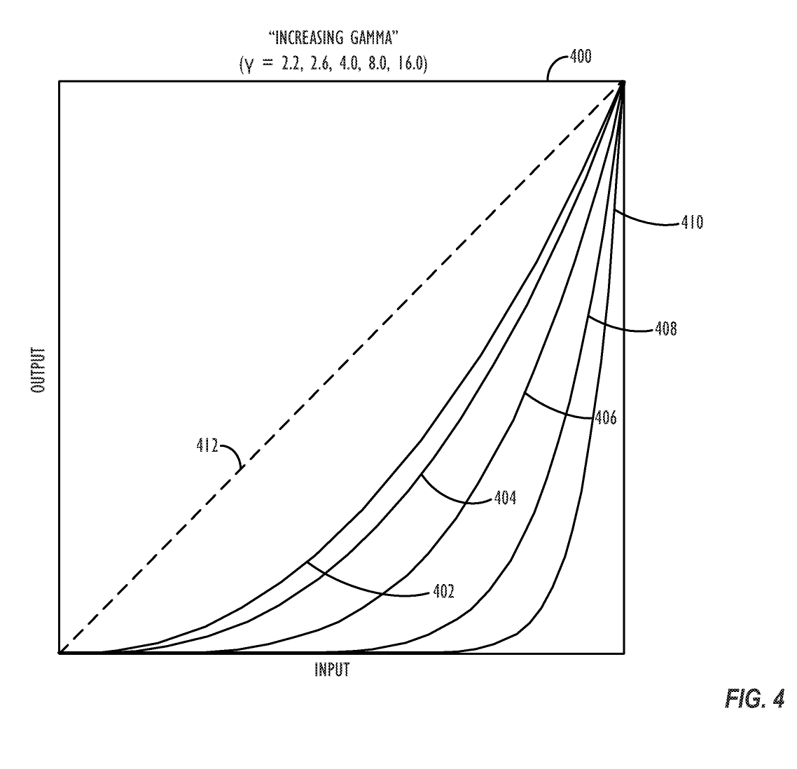

Referring now to FIG. 4, a graph 400 of a plurality of gamma functions with increasing gamma values is shown. For example, function 402 represents a gamma value of 2.2; function 404 represents a gamma value of 2.6; function 406 represents a gamma value of 4.0; function 408 represents a gamma value of 8.0; and function 410 represents a gamma value of 16.0. Notice that, as the value of the gamma decreases, the slope of the curves begin to increase drastically at lower and lower input values. Dashed line 412 represents a hypothetical linear transfer function with a slope of 1.

As mentioned above, because of the nature and shape of gamma curves, for a given quantized precision input, e.g., 8-bit input, dramatically more bits, e.g., 17 bits total, are required for the linear output space to meet the requirement that every unique input value produce a unique output value, such that the original signal may be reproduced by the inverse gamma function. Thus, it would be beneficial to be able to reduce the number of bits needed to encode the gamma function. Since scalars and other linear-space computations are expensive, any bit reductions save greatly in terms of transistors, space, power, and computational expense.

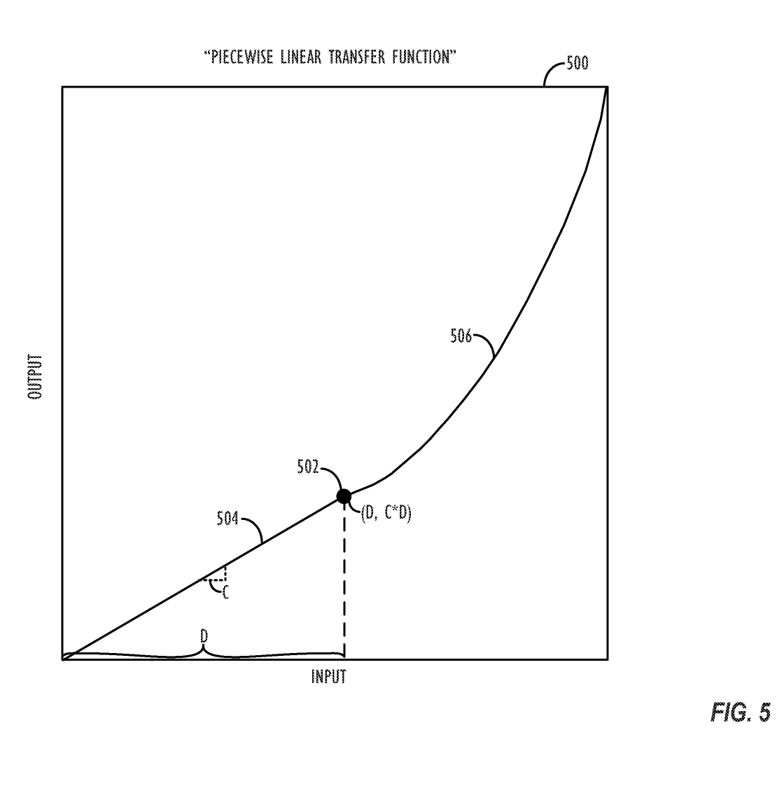

Referring now to FIG. 5, one graph 500 of an exemplary piecewise linear transfer function that may be used to reduce the number of bits required in the linear domain is illustrated. Graph 500 comprises a piecewise linear transfer function defined largely by two segments. Segment 504 comprises a linear segment that begins at coordinates (0,0) and continues to intersection point 502. As illustrated in FIG. 5, the intersection point 502 is located at an input value of ‘d,’ and linear segment 504 has a slope of ‘c.’ Thus, the intersection point 502 is located at coordinates (d, c*d). The second segment of graph 500 comprises an offset curve portion 506. Offset curve 506 may comprise, e.g., a pure power function or a polynomial curve. According to some preferred embodiments, the value of d is made as small as possible in order to minimize the length of the linear segment of the transfer function. As may now be understood, the longer the linear segment, the more deviation there is from the ideal pure power curve. The slope of the linear segment, c, however, is limited, thus intentionally under-cutting this area of the curve, necessitating over compensation to ‘catch up’ later.

The number of bits required in linear space is bounded between:

((1/(2̂inputbits−1))̂gamma)*2̂linearbits=0.5

and

((1/(2̂inputbits−1))̂gamma)*2̂linearbits=1.0.

These equations have been determined by analyzing what occurs at the first quantized step of the curve. Because the signal is steepest at that point, it may be used to characterize the number of bits required.

Thus, according to one embodiment, a method to reduce the number of bits required in the linear domain comprises substituting a piecewise linear transfer function (e.g., a line segment followed by an offset curve, as is shown in FIG. 5) for the pure-power function. The method may also comprise limiting the slope of the linear segment 504 of the curve to constrain the number of (additional) linear bits required (over the input precision) to a desired number.

According to some embodiments, one or more of the following constraints may be optimized over in order to generate a piecewise linear transfer function defined as:

y(x)=c*x, where x<d

y(x)=(a*x*b)̂curve_gamma, where x>=d.

Exemplary Constraints for Determining the Piecewise Linear Transfer Function

Constraint 1.) The piecewise linear transfer function intersects the coordinates (1,1). In other words: 1=(a*b)̂curve_gamma.

Constraint 2.) The slope of the linear segment is limited according to the following equation: log₂(1/c)=additional_bits.

Constraint 3.) The linear segment and the offset curve are continuous with one another where they intersect. In other words: c*d=(a*d+b)̂curve_gamma.

Constraint 4.) The linear segment and the offset curve have equal slopes where they intersect. In other words: diff(c*d)=diff((a*d+b) ̂curve_gamma).

Constraint 5.) The area under the piecewise linear transfer function is optimized to be equal or substantially equal to the area under an ideal curve (i.e., pure power function). In other words: integrate((x̂gamma),x,0,1)=integrate (c*x, x, 0, d)+integrate ((a*x+b) ̂curve_gamma, x, d, 1).

Constraint 6.) The mean square error is minimized between the piecewise linear transfer function and the ideal curve (i.e., pure power function).

Constraint 7.) Other possibly perceptual-based error metrics to correct for differences in human perception of visual and/or auditory signals.

As mentioned above, by applying these techniques, the additional number of bits required in the linear space may be reduced from nine to four or fewer—depending on the acceptable level of difference between the curves (differences between the modeled piecewise linear functions and the pure-power curve will appear as subtle tone shifts at reasonable levels of bit conservation).

Polynomial Approximations for the Offset Curve

Further, piecewise linear/polynomial approximations may be solved for (instead of piecewise linear/pure-power functions described above) for the piecewise linear transfer function. Polynomial approximations of cubic—or even second order—may be solved for to meet one or more of the constraints enumerated above, while still providing good approximations of the ideal pure-power function representation and requiring far less computational resources to compute or table size to store.

According to one embodiment, a cubic polynomial may be solved for of the form:

y(x)=c*x, where x<d

y(x)=k₃x³+k₂x²+k₁x+k₀, where x>=d.

If the above mentioned constraints that: 1) y(0)=0; 2) y(1)=1; 3) y(d)=d*c; 4) y′(d)=c; and 5) the area under y(x) is equal to the area under an ideal pure power function having a gamma value, g, are also applied in the context of the cubic polynomial approximation of the offset curve, then additional constraints may be implied that:

k₃+k₂+k₁+k₀=1; (from constraint 2) 1)

k₃d³+k₂d²+k₁d+k₀=d*c; (from constraint 3) 2)

3k₃d²+2k₂d+k₁=c; (from constraint 4) and 3)

(12(1−d)k₀+6(1−d²)k1+4(1−d³)k2+3(1−d⁴)k3)/12+(cd²/2)=1/(g+1) (from constraint 5). 4)

Solving the above system of equations for k₃, k₂, k₁, and k₀ yields:

$${k}_{3} = \frac{1}{{( d - 1 )}^{2}} ( \frac{- 4}{d - 1} * 1 + \frac{- 8}{d - 1} * ( d * c ) + 2 * ( c ) + \frac{- 1}{{d}^{2} - 2 d + 1} * ( \frac{12}{g + 1} - 6 c {d}^{2} ) )$$

$${k}_{2} = \frac{1}{{( d - 1 )}^{2}} ( \frac{3 ( 3 d + 1 )}{d - 1} * 1 + \frac{3 ( 5 d + 3 )}{d - 1} * ( d * c ) + \frac{- 3 ( d + 1 )}{1} * c + \frac{2 d + 1}{{d}^{2} - 2 d + 1} * ( \frac{12}{g + 1} - 6 c {d}^{2} ) )$$

$${k}_{1} = c - ( 3 {k}_{3} {d}^{2} + 2 {k}_{2} d )$$

$${k}_{0} = 1 - ( {k}_{3} + {k}_{2} + {k}_{1} )$$

The preferred value of d may then be determined numerically, e.g., by minimizing the maximum deviation between the piecewise linear transfer function having the cubic polynomial offset curve the ideal pure-power function with gamma value, g. Once d is known, the value of c may be solved for trivially by plugging the solved-for value of d into the solved cubic polynomial offset curve.

As mentioned above, second order polynomial approximations (as well as higher-order polynomial approximations) for the offset curve may also be numerically determined using the constraints and methods described above with respect to a third-order polynomial approximation. The choice of what order polynomial to use for a given implementation may depend, e.g., on the system's processing constraints, tolerance for error, and/or tolerance for artifacts in the resulting (i.e., after inversion back to non-linear space) data.

Stochastic Dithering

To further reduce bit requirements for linear-space computations (such as scaling), a stochastic dither may be applied preceding a quantization. For instance, with 8-bit, 2.2 gamma input data linearized using the aforementioned piecewise linear function techniques, only 12 bits may be required in linear space (to avoid banding artifacts), versus the 17 bits that would be required if a pure power transfer function were used.

If stochastic noise is also added (e.g., centered at the quantization's least significant bit), the signal may further be quantized to, e.g., 10 bits for further linear-space computation without creating objectionable artifacts. Adding appropriate noise to the signal (e.g., centered at the quantization of triangular distribution, etc.) allows for quantization to fewer bits, while preserving original signal without introducing banding artifacts. Since scalars and other linear-space computations are expensive, any bit reductions save greatly in terms of transistors, space, power, and computational expense. In the examples described above, a linear-space scalar operation may be reduced from requiring 17 bits of precision to just 10 bits—a dramatic savings!

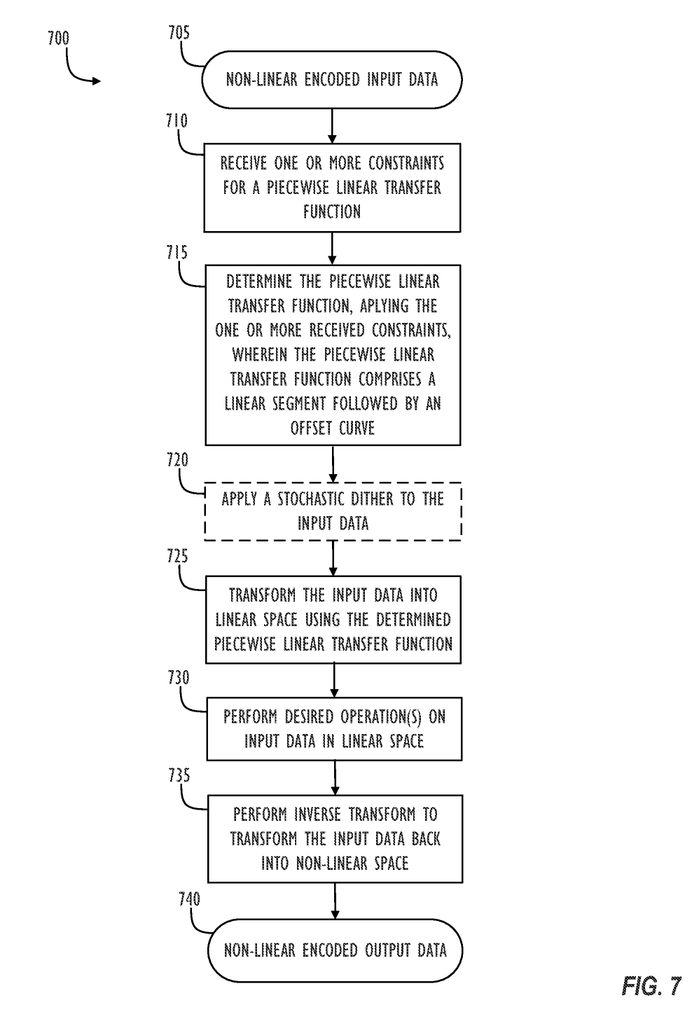

Referring now to FIG. 7, a process 700 of reducing the bit-depth required for linearizing data according to some embodiments is shown in flowchart form. First, non-linear encoded input data may be received (Step 705). Next, the process may receive one or more constraints for a piecewise linear transfer function that is to be determined (Step 710). Next, the process may determine the piecewise linear transfer function using the one or more received constraints (Step 715). According to some embodiments, the piecewise linear transfer function may comprise a linear segment followed by an offset curve. However, other types of piecewise linear transfer functions may also be determined, so long as they reduce the number of bits required to satisfactorily linearize the input data, as compared to the use of a pure power function. For example, another possibility is to use similar techniques to optimize for gamma hardware involving a list of linear segments, which are then interpolated to produce a result. In some embodiments, there may be a set list of segment end points with programmable vertices. Next, a stochastic (or other) dither may optionally be applied to the input data, followed by quantizing to fewer bits, in order to further reduce the bit requirements for linear-space computations (Step 720). Next, the input data may actually be transformed using the determined piecewise linear transform function (Step 725), the desired operations may be performed on the input data in linear space (Step 730), and then an inverse transform may be applied to the input data to put it back into non-linear space (Step 735). Finally, the non-linear encoded output data (Step 740) will have been created and may be displayed and/or sent to another computing device, as is desired.

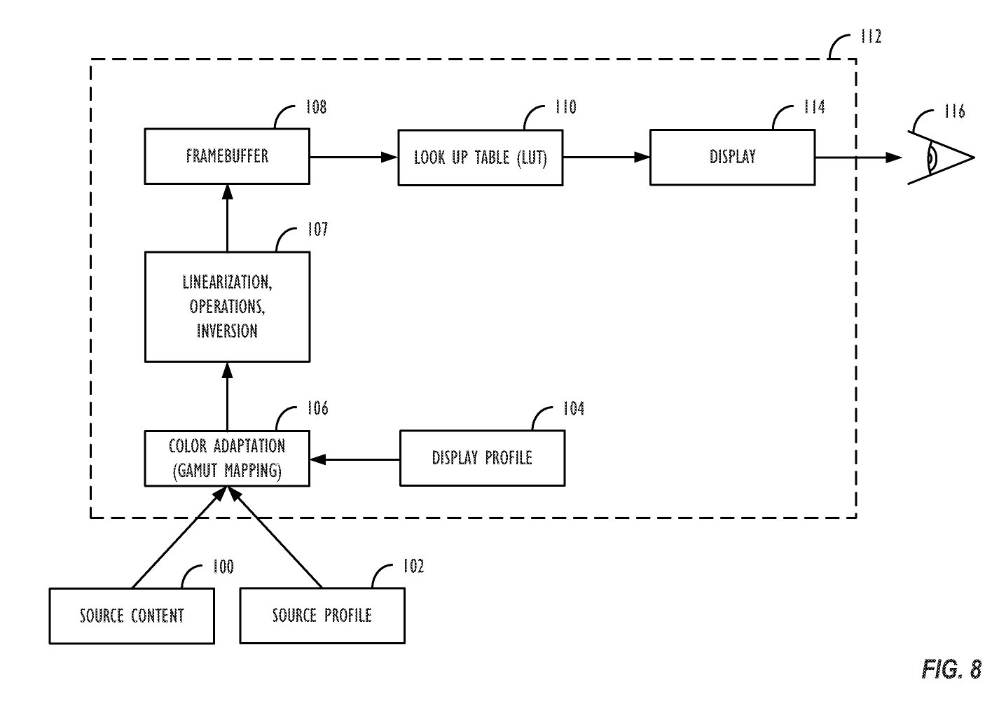

Referring now to FIG. 8, a system for performing graphical operations in linear space is shown, in accordance with one embodiment. FIG. 8 illustrates the same system as is illustrated in FIG. 1, with the addition of block 107 labeled “Linearization, Operations, Inversion.” It is within this block 107 of the system that the aforementioned piecewise linear transform functions may be determined and applied so that the desired graphical operations may be performed in linear space (with reduced bit depth, as compared to prior art systems), and then inverted back to non-linear space before being displayed to a user.

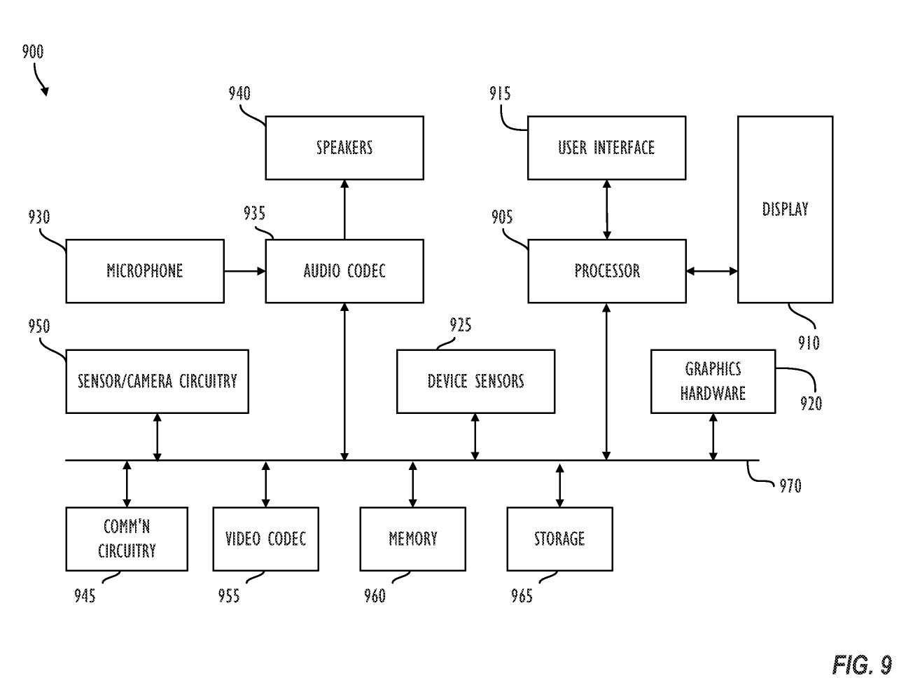

Referring now to FIG. 9, a simplified functional block diagram of an illustrative electronic device 900 is shown according to one embodiment. Electronic device 900 may include processor 905, display 910, user interface 915, graphics hardware 920, device sensors 925 (e.g., proximity sensor/ambient light sensor, accelerometer and/or gyroscope), microphone 930, audio codec(s) 935, speaker(s) 940, communications circuitry 945, digital image capture unit 950, video codec(s) 955, memory 960, storage 965, and communications bus 970. Electronic device 900 may be, for example, a personal digital assistant (PDA), personal music player, mobile telephone, or a notebook, laptop or tablet computer system.

Processor 905 may be any suitable programmable control device capable of executing instructions necessary to carry out or control the operation of the many functions performed by device 900 (e.g., such as the linearization and/or processing of images in accordance with operations in any one or more of the Figures). Processor 905 may, for instance, drive display 910 and receive user input from user interface 915 which can take a variety of forms, such as a button, keypad, dial, a click wheel, keyboard, display screen and/or a touch screen. Processor 905 may be a system-on-chip such as those found in mobile devices and include a dedicated graphics processing unit (GPU). Processor 905 may be based on reduced instruction-set computer (RISC) or complex instruction-set computer (CISC) architectures or any other suitable architecture and may include one or more processing cores. Graphics hardware 920 may be special purpose computational hardware for processing graphics and/or assisting processor 905 process graphics information. In one embodiment, graphics hardware 920 may include a programmable graphics processing unit (GPU).

Sensor and camera circuitry 950 may capture still and video images that may be processed to generate images, at least in part, by video codec(s) 955 and/or processor 905 and/or graphics hardware 920, and/or a dedicated image processing unit incorporated within circuitry 950. Images so captured may be stored in memory 960 and/or storage 965. Memory 960 may include one or more different types of media used by processor 905, graphics hardware 920, and image capture circuitry 950 to perform device functions. For example, memory 960 may include memory cache, read-only memory (ROM), and/or random access memory (RAM). Storage 965 may store media (e.g., audio, image and video files), computer program instructions or software, preference information, device profile information, and any other suitable data. Storage 965 may include one more non-transitory storage mediums including, for example, magnetic disks (fixed, floppy, and removable) and tape, optical media such as CD-ROMs and digital video disks (DVDs), and semiconductor memory devices such as Electrically Programmable Read-Only Memory (EPROM), and Electrically Erasable Programmable Read-Only Memory (EEPROM). Memory 960 and storage 965 may be used to retain computer program instructions or code organized into one or more modules and written in any desired computer programming language. When executed by, for example, processor 905 such computer program code may implement one or more of the methods described herein.

It is to be understood that the above description is intended to be illustrative, and not restrictive. The material has been presented to enable any person skilled in the art to make and use the invention as claimed and is provided in the context of particular embodiments, variations of which will be readily apparent to those skilled in the art (e.g., some of the disclosed embodiments may be used in combination with each other). In addition, it will be understood that some of the operations identified herein may be performed in different orders. The scope of the invention therefore should be determined with reference to the appended claims, along with the full scope of equivalents to which such claims are entitled. In the appended claims, the terms “including” and “in which” are used as the plain-English equivalents of the respective terms “comprising” and “wherein.”

1. A non-transitory program storage device, readable by a programmable control device and comprising instructions stored thereon to cause the programmable control device to:
receive non-linear encoded input data, wherein the received non-linear encoded input data has a first quantized bit-depth;
determine a first transfer function; and
transform the received non-linear encoded input data into linear output data having a second quantized bit-depth according to the first transfer function,
wherein the first transfer function comprises a piecewise linear function, the piecewise linear function defined by a first linear segment followed, after a first input value, by an offset curve,
wherein the first linear segment is continuous with the offset curve at the first input value, and
wherein the slopes of the first linear segment and the offset curve at the first input value are the same.

2. The non-transitory program storage device of claim 1, wherein the offset curve comprises a power function.

3. The non-transitory program storage device of claim 1, wherein the offset curve comprises a polynomial function.

4. The non-transitory program storage device of claim 1, wherein the instructions further comprise instructions to cause the programmable control device to apply a stochastic dither to the non-linear encoded input data before the instructions to transform the received non-linear encoded input data are performed.

5. The non-transitory program storage device of claim 1, wherein the first linear segment has a first slope value, and wherein the first slope value is limited, at least in part, by the difference between the second quantized bit-depth and the first quantized bit-depth.

6. The non-transitory program storage device of claim 1, wherein the first transfer function is determined based, at least in part, on an area under an ideal power function curve defined over the same range of input values as the first transfer function.

7. The non-transitory program storage device of claim 1, wherein the first transfer function is determined based, at least in part, on minimizing an error between an ideal power function curve defined over the same range of input values as the first transfer function and the first transfer function.

8. A system, comprising:
a memory having, stored therein, computer program code; and
a programmable control device operatively coupled to the memory and comprising instructions stored thereon to cause the programmable control device to:
receive non-linear encoded input data, wherein the received non-linear encoded input data has a first quantized bit-depth;
determine a first transfer function; and
transform the received non-linear encoded input data into linear output data having a second quantized bit-depth according to the first transfer function,
wherein the first transfer function comprises a piecewise linear function, the piecewise linear function defined by a first linear segment followed, after a first input value, by an offset curve,
wherein the first linear segment is continuous with the offset curve at the first input value, and
wherein the slopes of the first linear segment and the offset curve at the first input value are the same.

9. The system of claim 8, wherein the offset curve comprises a power function.

10. The system of claim 8, wherein the offset curve comprises a polynomial function.

11. The system of claim 8, wherein the instructions further comprise instructions to cause the programmable control device to apply a stochastic dither to the non-linear encoded input data before the instructions to transform the received non-linear encoded input data are performed.

12. The system of claim 8, wherein the first linear segment has a first slope value, and wherein the first slope value is limited, at least in part, by the difference between the second quantized bit-depth and the first quantized bit-depth.

13. The system of claim 8, wherein the first transfer function is determined based, at least in part, on an area under an ideal power function curve defined over the same range of input values as the first transfer function.

14. The system of claim 8, wherein the first transfer function is determined based, at least in part, on minimizing an error between an ideal power function curve defined over the same range of input values as the first transfer function and the first transfer function.

15. A method, comprising:
receiving non-linear encoded input data, wherein the received non-linear encoded input data has a first quantized bit-depth;
determining a first transfer function; and
transforming the received non-linear encoded input data into linear output data having a second quantized bit-depth according to the first transfer function,
wherein the first transfer function comprises a piecewise linear function, the piecewise linear function defined by a first linear segment followed, after a first input value, by an offset curve,
wherein the first linear segment is continuous with the offset curve at the first input value, and
wherein the slopes of the first linear segment and the offset curve at the first input value are the same.

16. The method of claim 15, wherein the offset curve comprises a power function or a polynomial function.

17. The method of claim 15, further comprising applying a stochastic dither to the non-linear encoded input data before the act of transforming the received non-linear encoded input data is performed.

18. The method of claim 15, wherein the first linear segment has a first slope value, and wherein the first slope value is limited, at least in part, by the difference between the second quantized bit-depth and the first quantized bit-depth.

19. The method of claim 15, wherein the first transfer function is determined based, at least in part, on an area under an ideal power function curve defined over the same range of input values as the first transfer function.

20. The method of claim 15, wherein the first transfer function is determined based, at least in part, on minimizing an error between an ideal power function curve defined over the same range of input values as the first transfer function and the first transfer function.
